(19) United States
(12) Patent Application Publication
(10) Pub. No.: US 2003/0178837 A1
(43) Pub. Date: Sep. 25, 2003

(54) Repositionably adherent note sheets which permit the passage of light, and assemblies thereof

(76) Inventors: Lam Ung, Arroyo Grande, CA (US); Tavys Quinn Ashcroft, Arroyo Grande, CA (US)

Correspondence Address: Lam Ung and Tavys Ashcroft, 965 Branch Mill Road, Arroyo Grande, CA, 93420, US

(21) Appl. No.: 10/104,041

(22) Filed: Mar. 22, 2002

(51) Int. Cl. B42D 19/00

(52) U.S. Cl. 281/9

(57) ABSTRACT

A repositionably adherent note sheet is provided which improves upon previous note sheets of similar design in that the note sheet of the present invention permits the passage of light, allowing a body behind it to be visible. The present invention adheres by means of repositionable adhesive and is receptive to indicia made by various writing implements. These note sheets may be sandwiched together into stacks, forming a convenient note pad. Such note sheets may also have tabs along one side, allowing easy referencing when inside a book or other volume of documents.

### CROSS-REFERENCE TO RELATED APPLICATIONS

Not applicable

### BACKGROUND

1. Field of the Invention

This invention relates in general to note sheets, or pads and other assemblies thereof, which are adherent by means of repositionable adhesive and made of sheet material which permits the passage of light thus allowing a body behind it to be visible.

### BACKGROUND

2. Description of Prior Art

A common item of the modern office is the pad of “sticky notes.” Such a pad has sheets of notepaper with repositionable adhesive on a portion of the bottom side of each sheet. One or more sheets can be easily removed from the pad and secured to another surface. Such pads are manufactured, for example, by Minnesota Mining and Manufacturing Company under the “Post-It” trademark.

A disadvantage of such note sheets, like “Post-It” notes, is that they are opaque. For instance, in the case of library books, taking notes on an opaque note sheet, placed directly over text, prevents the original text from being read. These opaque note sheets must be placed in margins or must be lifted to reveal any obscured text. Either way, the note sheets will not reference directly to the text being annotated. Short of writing directly upon the surface of the book, the only option is to photocopy the book and annotate the copies. Photocopying books is wasteful of paper, time, and money as well as unnecessarily creating multiple copies of the same text. Writing directly in a library book is discourteous to future users of the book and results in defacement of public property.

The present invention would solve this problem by allowing valuable books and documents, such as library materials and school textbooks, to be written on, annotated, or highlighted, without defacing them or lowering their value. The note sheet of the present invention, being made of material which permits the passage of light, allows the existing text of the book, document, or other surface, as well as the written notes, annotations, and highlights to be viewed at the same time. The note sheet can also be easily removed at any time by means of its repositionable adhesive, restoring the book, document, or other surface to its former state. After removal, the note sheet of the present invention could be re-adhered to the same page. All notes, annotations, or highlights would be in the same place again. Such note sheets could also be made with index tabs, allowing annotated pages in a book to be easily found.

### SUMMARY

This invention comprises a note sheet which permits the visibility of a body behind it, is receptive to indicia from writing implements, and adheres by means of repositionable adhesive.

### OBJECTIVES

Accordingly, several objectives of the present invention are:

(a) To provide a note sheet which permits the passage of light, thus allowing any written marks made upon the surface of the note sheet to be visible simultaneously with the body behind the note;

(b) To provide a note sheet with a surface which is receptive to marks made by various writing implements as well as allowing erasure of non-permanent marks;

(c) To emulate the act of writing directly upon a body, by means of a note sheet which permits the passage of light and is receptive to written marks;

(c) To provide an adherent note sheet which can be easily removed and reaffixed at any time by means of its repositionable adhesive;

(d) To provide a note sheet which protects from defacement when writing directly upon a body;

(e) To provide a note sheet which, after removal from a body, allows any markings to remain upon said note for later referencing when reaffixed to said body;

(f) To provide a note sheet which eliminates the need to photocopy as a means to safely make marks upon the contents of a book, document, or other surface;

Further applications of the present invention will become apparent from a consideration of the ensuing description and drawings.

### DRAWING FIGURES

FIG. 1A is a top view of a sheet which permits the passage of light and has a writing surface on its top side.

FIG. 1B is a bottom view of a sheet which permits the passage of light and has repositionable adhesive on a portion of its bottom side.

FIG. 2 is an isometric view of a stack, comprised of a multitude of the sheets represented in FIGS. 1A and 1B, which has a writing surface on the top side of each sheet and repositionable adhesive on a portion of the bottom side of each sheet.

FIG. 3A is an exploded view of a stack, comprised of a multitude of the sheets represented in FIGS. 1A and 1B, said stack having an index tab along one edge of each sheet.

FIG. 3B is an isometric view of the note sheets from FIG. 3A being used in a book.

FIG. 4 is a top view of the note sheet represented in FIGS. 1A and 1B with the addition of perforations, allowing division into separate note sheets of predetermined or varying sizes, and perforated index tabs which can be removed if desired.

FIG. 5 is an isometric view of a roll of the note sheet presented in FIG. 4.

### REFERENCE NUMERALS IN DRAWINGS

1 note sheet which permits the passage of light

2 writing surface

3 repositionable adhesive

4 index tab

5 perforation

6 perforated index tab

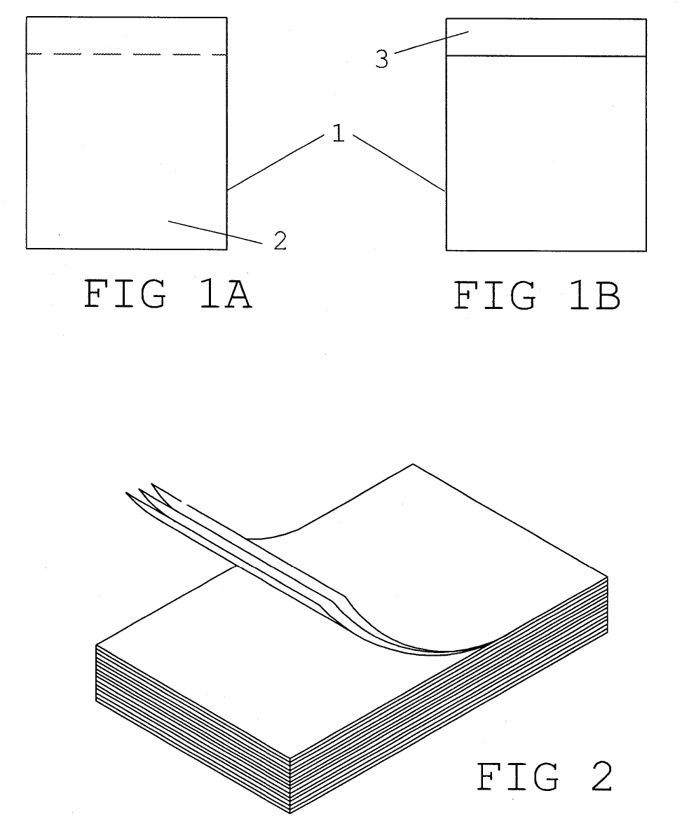

Description—FIGS. 1A, 1B, and 2—Preferred Embodiments

The note sheet of the present invention is illustrated in FIGS. 1A and 1B.

The note sheet as shown in FIG. 1A (top view) is a sheet which permits the passage of light 1 with a writing surface 2 on its top side.

The note sheet as shown in FIG. 1B (bottom view) is a sheet which permits the passage of light 1 with a repositionable adhesive 3 upon a portion of its bottom side.

A preferred embodiment of the present invention is the note pad assembly, which is illustrated in FIG. 2. The note pad assembly is comprised of a stack of sheets which permit the passage of light. The top of each sheet has a surface which is receptive to writing, erasing, highlighting and other such uses, with repositionable adhesive on a portion of the bottom side of each sheet.

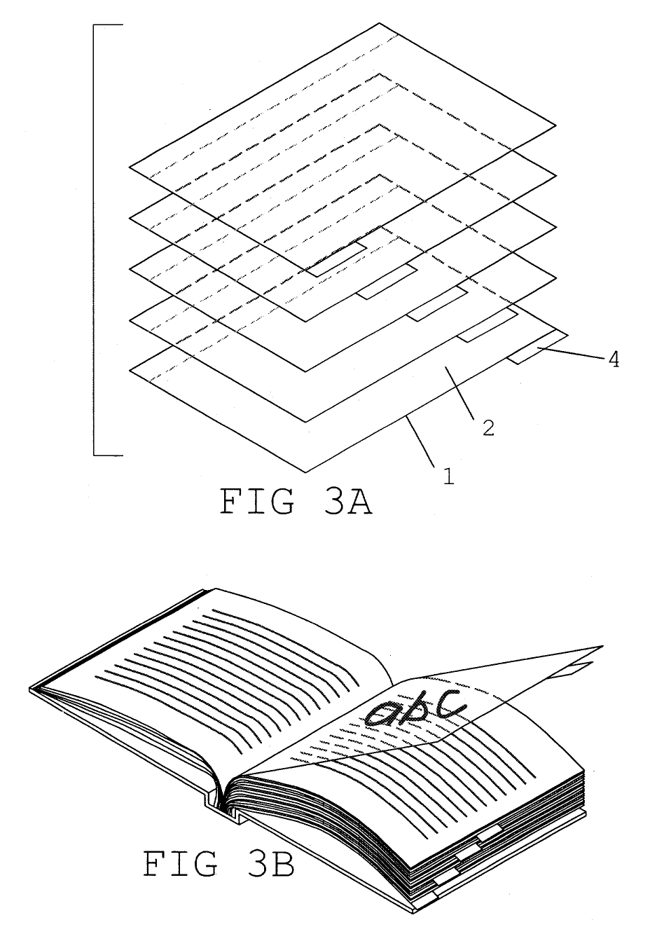

### FIGS. 3-5—ADDITIONAL EMBODIMENTS

Additional embodiments are shown in FIGS. 3A, 3B, 4, and 5.

FIG. 3A (exploded view) shows a stack of sheets which permit the passage of light 1, have a writing surface 2, and have an index tab 4 along one edge of each sheet. These tabs are placed on each sheet with an offset spacing suitable for differentiation.

FIG. 3B (isometric view) shows the note sheets as they might be used in a book. The index tabs of the note sheets throughout the book can be seen protruding from the book's edge. A page is shown lifted from the book, displaying that the page is left in its original condition when the note sheet is removed.

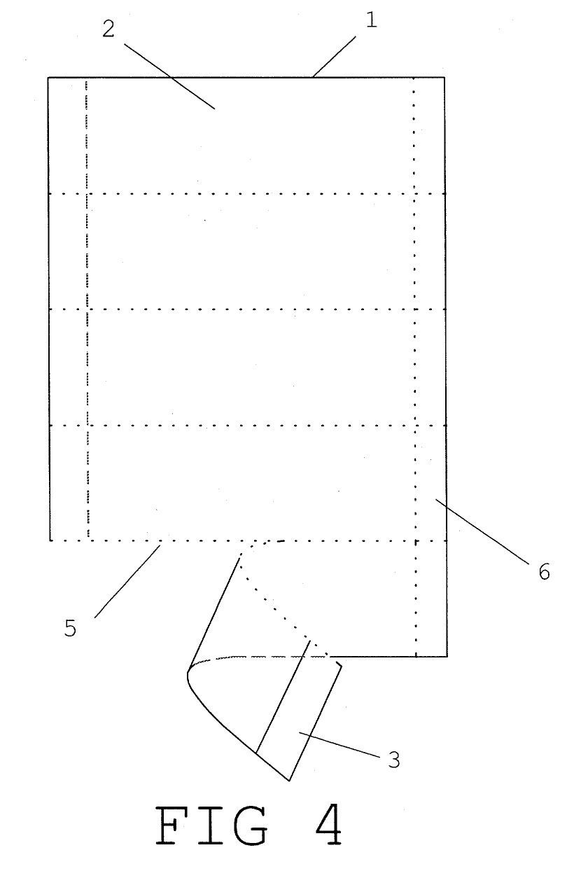

FIG. 4 (top view) shows a sheet which permits the passage of light 1, has a writing surface 2, and further includes perforations 5. These perforations allow separation into smaller note sheets, each note sheet having repositionable adhesive 3 on a portion of its bottom side, as well as perforated index tabs 6 along said sheet's edge.

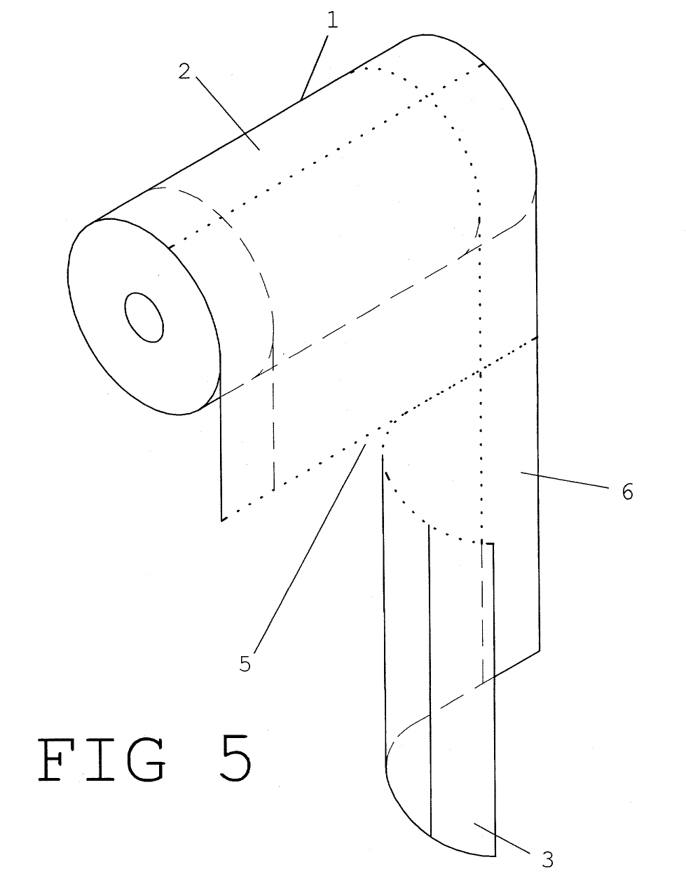

FIG. 5 (isometric view) shows a continuous roll of the sheet represented in FIG. 4. As in FIG. 4, this note sheet includes perforations 5, allowing division into smaller note sheets of predetermined or varying sizes. A portion of this roll is shown being removed, displaying how individual sheets of many sizes can be made from this one roll. Each sheet will have a perforated index tab 6, a writing surface 2, and repositionable adhesive 3 on a portion of its bottom side.

### ADVANTAGES

From the description above, a number of advantages of the repositionably adherent note sheet which permits the passage of light become evident:

(a) The present invention removes the functional restrictions inherent to opacity by permitting visibility through the writing surface of the note sheet.

(b) Bodies can safely be annotated without leaving defacing marks.

(c) The note sheet of the present invention removes the need to photocopy a book or document in order to safely make written marks upon it.

(d) The invention maximizes time efficiency by eliminating the need for photocopying or using opaque notes such as index cards and “Post-It” notes.

### OPERATION—FIG. 3B

FIG. 3B shows a note sheet of the present invention over a page in a book. This use is similar to that of opaque note sheets in current use. The present invention, being made of a material which permits the passage of light, allows visibility of both the writing upon the surface of the note sheet and the text behind the note sheet. This visibility permits the note sheet to be placed directly over text, emulating the functionality of writing directly upon the surface of the page. Once the note sheet is removed, the page beneath will be left in its former condition. The tabs along one edge of the note sheet act as a bookmark allowing the written annotations to be quickly found in a book.

### CONCLUSION, RAMIFICATIONS, AND SCOPE

Thus the reader will see that the note sheet of the present invention can be used by anyone such as students, researchers, and office assistants. The invention provides an economical alternative to photocopying and is more time efficient than using index cards and “Post-It” notes to take notes and/or make references.

While the above description contains many specificities, these should not be construed as limitations on the scope of the invention but rather as an exemplification of one preferred embodiment thereof. Many other variations are possible. For example, the note sheets may:

(a) be stacked in an imbricate manner which allows easy removal of one sheet from the stack;

(b) be of a non-rectangular shape which also allows easy removal of one sheet from the stack;

(c) have shapes, text, letters, logos, or other designs printed upon them;

We claim the following:

1. A sheet which:
a) permits the passage of light whereby said sheet allows a body behind it to be visible,
b) is adherent by means of a repositionable adhesive whereby said sheet can be affixed to and removed from said body, and
c) is receptive to indicia whereby said sheet can receive marks from various writing implements.

2. The sheet of claim 1, whereby said sheet is receptive to the removal of non-permanent indicia from various erasable writing implements.

3. The sheet of claim 1, wherein:
a) the top side of said sheet is receptive to indicia and the removal of non-permanent indicia, and
b) the bottom side of said sheet is repositionably adherent by means of repositionable adhesive.

4. The sheet of claim 1, further including pigmentation which permits the passage of light.

5. The sheet of claim 1, further including one or a multitude of shapes, letters, numbers, or other designs punched out of said sheet's material.

6. The sheet of claim 1, further including one or multitude of shapes, letters, numbers, or other designs printed upon said sheet.

7. The sheet of claim 1, further including a tab or tabs.

8. The sheet of claim 1, further including perforations, allowing division of said sheet into separate sheets of predetermined or varying sizes.

9. The sheet of claim 8, further including one or a multitude of perforated tabs which may be individually removed.

10. The sheet of claim 1, wherein said sheet is of a predetermined length suitable for the formation of a roll.

11. The sheet of claim 10, wherein said sheet is in the form of a roll.

12. A multitude of the sheet of claim 3, forming a stack.

13. The stack of claim 12, wherein the bottom side of a sheet is adhered, by means of its repositionable adhesive, to the top side of the adjacent sheet in the stack.

14. The stack of claim 12, further including a bottom-most sheet or film, adhered to the bottom of the stack by means of the adhesive of the adjacent sheet, said bottom-most sheet or film protecting the adhesive of said adjacent sheet.

15. The stack of claim 12, further including a tab or tabs on each sheet, said tabs being individually positioned on each sheet throughout the stack with an offset spacing suitable for differentiation.

16. The stack of claim 12, wherein each sheet is placed in an imbricate manner to its adjacent sheet.

17. The stack of claim 12, wherein said stack is of a non-rectangular shape, allowing for easy removal of individual sheets from said stack.

18. A method for emulating the functionality of marking directly upon a body with a writing implement, comprising the steps of:
a) adhering a sheet of claim 1 to said body by means of said sheet's repositionable adhesive,
b) inscribing marks upon said sheet,
c) viewing said body and said marks simultaneously by means of said sheet permitting the passage of light.

19. A method for protecting a body from marks comprising the steps of:
a) adhering a sheet of claim 1 to said body by means of said sheet's repositionable adhesive,
b) inscribing marks upon said sheet,
c) removing said sheet, thereby removing said marks.
